(19) United States
(12) Patent Application Publication
(10) Pub. No.: US 2012/0036738 A1
(43) Pub. Date: Feb. 16, 2012

(54) CLEAT SOLE SYSTEMS

(76) Inventor: Willie Willis, Lakeland, FL (US)

(21) Appl. No.: 13/180,407

(22) Filed: Jul. 11, 2011

Related U.S. Application Data
(60) Provisional application No. 61/373,369, filed on Aug. 13, 2010.

(51) Int. Cl. A43B 13/22; B23P 19/04

(52) U.S. Cl. 36/73; 29/428

(57) ABSTRACT

The cleat sole protection system comprises an auxiliary sole having an outer sole and a midsole, a first set of straps that attach around the toe region of the cleated shoe, a second set of straps that attach around the metatarsal region of the cleated shoe, and in some embodiments there may be a third set of straps attached to the second set of straps which wrap around the back of the heel area of the cleated shoe. The auxiliary sole may comprise a wedge profile that gives the appearance of a sandal and is easily placed on the bottom of a cleated shoe and quickly strapped into place for the protection of wood, tile, and other types of flooring that can be damaged by cleated sports shoes.

### CROSS-REFERENCE TO RELATED APPLICATION

The present application is related to and claims priority from prior provisional application Ser. No. 61/373,369, filed Aug. 13, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of cleated shoes and more specifically relates to cleat protection devices.

### 2. Description of the Related Art

Many competitive sports in modern societies are performed outdoors on grassy or dirt surfaces and can cause the athlete to slip or slide because of the speed and directional changes required across the surfaces of loose materials. Cleat shoes were designed to prevent slippage while playing sports and to give the athlete every advantage in speed and maneuverability. During entry or exit of these playing fields an athlete should protect flooring from damage from the cleats, as well as protect themselves from falling and cleats from pre-mature wear.

Cleats are protrusions or studs attached to the bottom of the sports shoe that can be replaceable using a tool to remove the worn cleats, or permanently molded into the outer sole of the shoe. Depending on the type of surface, kind of sport, and even the wearer's position or role in the game, different cuts of boot and particularly stud arrangements are available. For hard fields, amateur participants may wear a sneaker shoe or a plastic-stud boot (known as a “molded sole”). In most sports and positions this is adequate, although on a well-grassed or sodden field, a screw stud is recommended for more grip; these may be metal, rubber or plastic. Presently, boot designs are based on the criteria of speed, power, touch or control with some boots offering a combination of these. Some sports require a cleat that is completely metal.

Cleat shoes are designed with a particular type of surface in mind. Use of the cleats on other surfaces can either cause damage to the surfaces or cause premature wear of the cleats requiring replacement of the studs or of the whole shoe. Metal cleats cause the most damage to almost all floor types and are usually forbidden on these surfaces. Changing shoes at the location of the sporting event is often inconvenient because traveling from the sports field to a non-sports area with hard flooring can be frequent during intermissions and the like. A ‘slip-on’ cleat or floor protector is needed that is quick and convenient to put on and will provide floor protection as well as protection of the cleat from the accelerated wear of hard surfaces and protection from the athlete from slipping.

If an athlete has to wear sport cleats there is always an issue, (having to remove ones cleats) when leaving or entering the dressing room, locker room, a restroom, a gym, an office, (basically any inside flooring), walking across pavement, or walking home on the sidewalk. Removing one's cleats is a must to protect the flooring from the spikes, to protect the athlete from slipping, and prevents excessive cleat spike wear. Having to remove one's sport cleats may create many issues, and likewise leaving the locker room without cleats may cause inconvenience as well. Typically, an athlete will be required to remove his/her cleats before entering the locker room after an event requiring another pair of shoes, removing ones cleats for a quick restroom trip during a game, and having to have a second pair of shoes for inside, sidewalk, or pavement usage all create inconvenience and unnecessary expense for the athlete. An individual always has to have a second pair of shoes and take the time and deal with the hassle of changing shoes during a busy time.

Various attempts have been made to solve the above-mentioned problems such as those found in U.S. Pat. Nos. 3,821,858; D326,949; 4,055,005; 2004/0074113; 3,913,243; and 5,367,794. This prior art is representative of cleat protectors. None of the above inventions and patents, taken either singly or in combination, is seen to describe the invention as claimed.

Ideally, a cleated shoe protection system should be user-friendly such that its use provides convenience and may be put on quickly and, yet would operate reliably and be manufactured at a modest expense. Thus, a need exists for a reliable cleat protection system to protect floors from damage and cleats from unnecessary wear and to avoid the above-mentioned problems.

### BRIEF SUMMARY OF THE INVENTION

In view of the foregoing disadvantages inherent in the known cleated shoe protection art, the present invention provides a novel cleat protection system. The general purpose of the present invention, which will be described subsequently in greater detail, is to provide greater speed and convenience in putting on cleat protectors to protect cleats, the athlete, and surfaces from incurring damage. Basically the cleat sole usage as described herein is for an individual to use while wearing athlete cleats for an event and use of the soles provided is for transporting the player(s) to and from the field without causing damage to surfaces, the athlete, or the cleats on the athletic shoes.

Generally, the “cleat sole pad” (auxiliary sole) turns sport cleats into an inside shoe or walking shoe. This cleat sole pad may comprise a compressed rubber composition sole which will attach to the bottom of a sports cleat via the stretch and Velcro® straps, making the cleat spikes a non issue. The cleat sole pad is intended to have holes to match the spikes on the bottom of an athlete's cleats or can be left as a pad with the cleat spikes setting on top of the pad. When an inside shoe or walking shoe is needed by an athlete wearing sport cleats, the cleat sole pad will be placed on the bottom of the user's sport cleats and held on via the stretch and Velcro® straps; creating an inside shoe or walking shoe. The present invention is designed to convert sporting cleats into an inside shoe or walking shoe which protects the athlete from slipping while walking on a hard surface, protects the user's sport cleats from excessive wear, protects inside flooring, speeds up any time exiting or entering of a sporting event or complex, and allows an athlete to focus on the event, not managing the complications of sport cleats usage.

More specifically, the present invention comprises a cleat sole protection system as disclosed herein preferably comprising an auxiliary sole having: an outer sole and a midsole, at least a first set of straps that attach around the toe region of the cleated shoe, at least a second set of straps that attach around the metatarsal region of the cleated shoe, and in some embodiments there may be a third set of straps attached to the second set of straps which may wrap around the back of the heel portion of the cleated shoe. The auxiliary sole may be flexible or may be non-flexible in certain embodiments and may comprise a wedge profile such that the heel portion of the cleat sole protection system is thicker than a toe portion. The auxiliary sole preferably comprises a profile that gives the appearance of a sandal. This featured profile is easily placed on the bottom of a cleated shoe and quickly strapped into place for the protection of wood, tile, and other types of flooring that can be damaged by cleated sports shoes. The auxiliary sole also substantially protects the cleats from excessive wear from walking on hardened surfaces such as pavement or rocks. The outer sole may comprise a grip design or in some embodiments, a non-grip surface texture.

The midsole of the present invention may comprise cleat receiving apertures preferably matching the arranged pattern of cleats on the cleated shoe(s). The cleat receiving apertures may comprise cubic profile apertures and/or cylindrical apertures (to match cleat profile on cleated shoes) and are located in the midsole and in an upper portion of the outer sole (a portion of the outer sole remaining is an isolator thereby preventing the cleats from contacting surfaces and from the surfaces contacting the cleats.) As a result the cleats may only contact portions of the auxiliary sole when worn. In most embodiments, the auxiliary sole may not comprise indented recesses for accepting the portions of the sports shoe (such as the heel or outer sole), but rather has a substantially smooth upper surface of the midsole wherein the cleated shoe may ‘ride’ on the upper surface of the auxiliary sole such that the cleated shoe is not recessed within the auxiliary sole (only the cleated are contained within the confines of the auxiliary sole, everything else is located adjacent.)

The first set of straps and the second set of straps are preferably non-removably attached to the auxiliary sole and are removably attached around the cleated shoe such that relative movement between the auxiliary sole and the cleated shoe is effectually minimized In this way auxiliary sole contact is insulatably-prevented between the cleated shoe and a walking planar surface. The third set of straps may be coupled to the second set of straps (or optionally to the first set in other embodiments) to prevent movement of the cleated shoe in relation to the auxiliary sole. The auxiliary sole does not comprise side engaging portions, toe inclusive portions, or heel inclusive portions so as to define front and backwards movement of the cleated shoe in relation to the auxiliary sole.

A method of use for a cleat sole protection system is also disclosed herein comprises the steps of: slipping on an auxiliary sole; attaching a first set of straps about a cleated shoe; attaching a second set of straps about the cleated shoe; wearing the auxiliary sole of the cleat sole protection system to prevent touch-contact between the cleated shoe and the planar surface; uncoupling the second set of straps; uncoupling the first set of straps; and removing the cleat sole protection system from the cleated shoe(s) such that a wearer-user is able to engage in at least one (sporting or the like) activity.

The method of use for a cleat sole protection system may further comprise the step of attaching a third set of straps around the cleated shoe when preparing to wear the cleat sole protection system to prevent forward and backward movement of the cleated shoe in relation to the auxiliary sole. The method of use for a cleat sole protection system may additionally comprise the step of uncoupling the third set of straps from around the cleated shoe before removing the cleat sole protection system.

The present invention holds significant improvements and serves as a cleated shoe protection system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, cleat sole protection system, constructed and operative according to the teachings of the present invention.

FIG. 1 shows a perspective view illustrating an in-use condition of a cleat sole protection system according to an embodiment of the present invention.

FIG. 2 is a perspective view illustrating an instep view of the cleat sole protection system comprising a non-grip (outer sole) bottom surface according to an embodiment of the present invention of FIG. 1.

FIG. 3 is a perspective outer side view illustrating the cleat sole protection system with a grip (outer sole) bottom surface according to an embodiment of the present invention of FIG. 1.

FIG. 4 is a top view of a midsole of the cleat sole protection system according to an embodiment of the present invention of FIG. 1.

FIG. 5 is a flowchart illustrating a method of use of the cleat sole protection system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to cleated shoes and more particularly to a cleat sole protection system as used to improve the protection of flooring, the athlete, and to reduce wear to cleats on cleated shoes.

Generally, cleat sole protection system 100 prevents undue wear on cleats 180 of cleated shoe(s)104 and to surfaces that cleated shoe(s)104 may come into contact with. Cleat sole protection system 100 of the present invention preferably comprises removable cleat sole 102 that is preferably made of compressed rubber 112 but in certain alternate embodiments may be made of leather or another resilient material(s) suitable to protect flooring 190 from cleated shoe(s) 104. Metal versions of cleats 180 or sharper non-metal versions of cleats 180 may dictate the need for a more resilient composition of midsole 130. Cleat sole 102 is preferably molded to fit the shape of cleated shoe(s)104, and is designed to allow athletes to walk freely indoors without causing damage to flooring 190 or to their cleats 180.

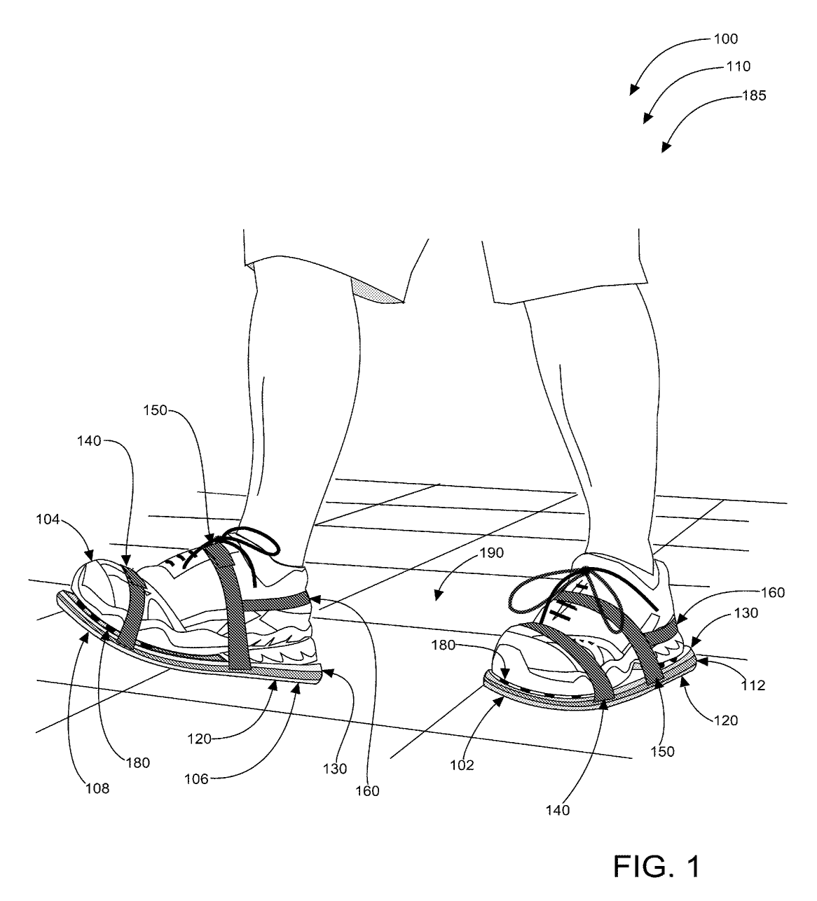

Referring to the drawings by numerals of reference there is shown in FIG. 1, a perspective view illustrating an in-use condition of cleat sole protection system 100 according to an embodiment of the present invention.

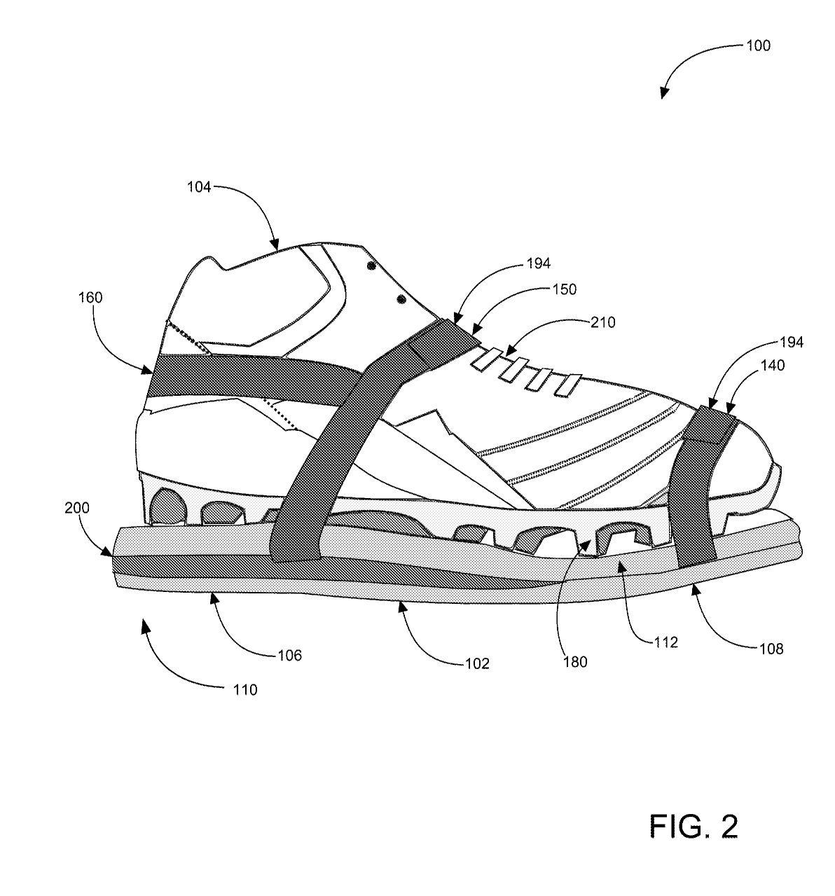

Referring more specifically now to the present invention, cleat sole protection system 100 preferably comprises at least one auxiliary sole 110 (normally to be sold in pairs) each having outer sole 120 and midsole 130; at least one first set of straps 140; at least one second set of straps 150; and in some embodiments, at least one third set of straps 160. Auxiliary sole 110 may be flexible or non-flexible and comprise a sandal profile wherein first set of straps 140 and second set of straps 150 are removably attached around (about) cleated shoe(s) 104 with adhesive fabric 194 or other suitable coupling means, as shown in FIG. 2. The present invention serves to substantially ensure that contact is insulatably-prevented between cleated shoe(s) 104 and at least one planar surface (such as flooring 190).

Third set of straps 160 (used within certain embodiments) couples to second set of straps 150 to effectively prevent movement of cleated shoe(s)104 in relation to auxiliary sole 110 since auxiliary sole 110 does not comprise side engaging portions, toe inclusive portions, or heel inclusive portions so as to define front and backwards movement. This is preferable since auxiliary sole 110 is more easily coupled and uncoupled from cleated shoe(s) 104. Outer sole 120 comprises protector 185 such that cleats 180 of cleated shoe(s) 104 are protected from wear and planar surface is protected from damage from cleats 180 while auxiliary sole 110 is removably attached to cleated shoe(s)104 during a non-cleat-use period.

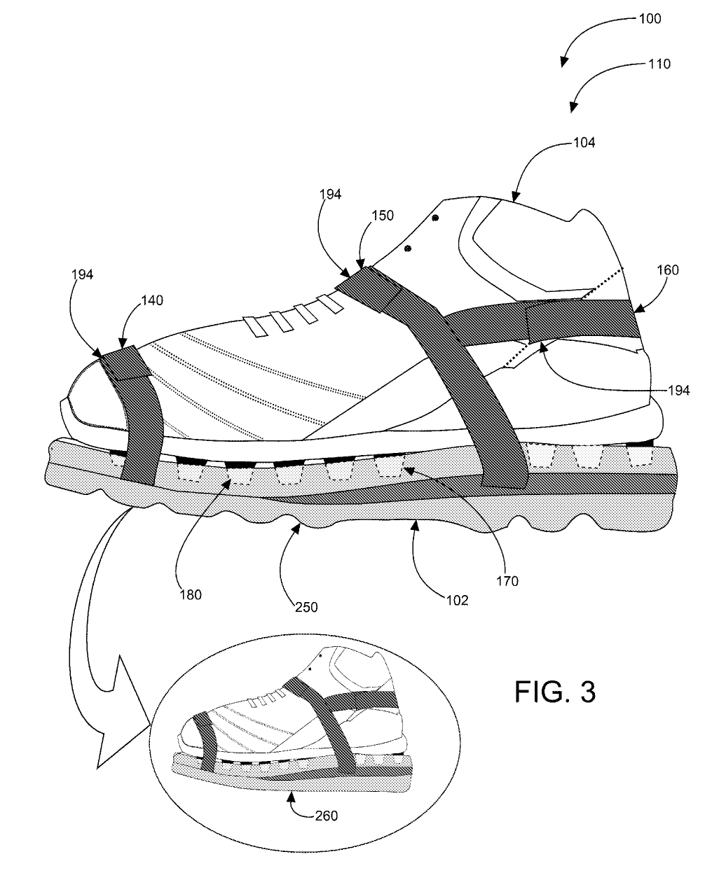

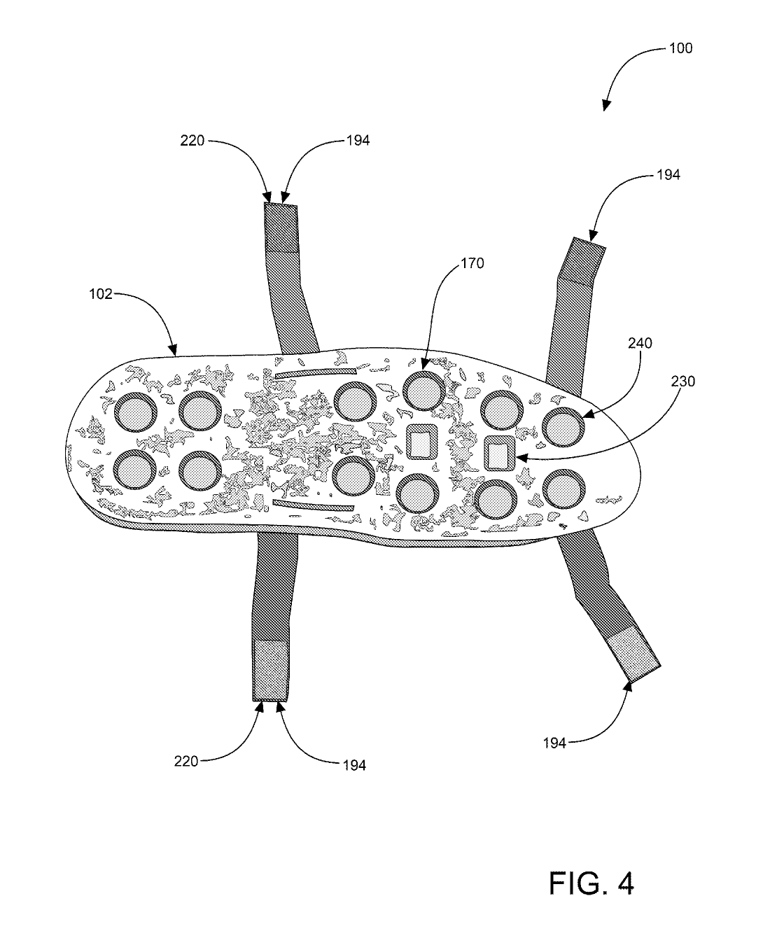

Referring now to FIG. 2, illustrating an inside view of cleat sole protection system 100 according to an embodiment of the present invention of FIG. 1. Auxiliary sole 110 comprises wedge profile 200 such that heel portion 106 of cleat sole protection system 100 is thicker than toe portion 108 (inclining upwardly sloping from toe towards the heel portion.) Cleat receiving apertures 170 are preferably located in midsole 130 and in an upper portion of outer sole 120, as shown in FIG. 3. The sandal profile provides that cleated shoe(s)₁₀₄ ‘rides’ on an upper surface of auxiliary sole 110 such that cleated shoe(s)₁₀₄ is not recessed within auxiliary sole 110, also providing for ease of coupling and uncoupling, as shown in FIG. 2. The straps are designed to be fastened via adhesive fabric 194 or other similar means around the toe portion 108 and metatarsal area 210. First set of straps 140 and second set of straps 150 are non-removably attached to auxiliary sole 110 and removably attached at distal end(s) 220 of the straps, as alluded to in FIG. 4. It should be appreciated that other suitably equivalent fastening means such as snaps, clips, clasps and other may be used to secure straps in place.

Referring now to FIG. 3, a perspective view illustrating an outer side view of cleat sole protection system 100 with a grip surface 250 and non-grip surface 260 (encircled view) of outer sole 120 bottom surface according to an embodiment of the present invention of FIG. 1. Outer sole 120 may have grip surface 250 (grooved—shown in FIG. 3) or non-grip surface 260 (non-grooved—shown in FIGS. 2 and 3) on the bottom of outer sole 120 for traction on various walking surfaces. Midsole 130 may be reasonably soft and formable to cleats 180 and/or may comprise cleat receiving apertures 170 for receiving cleats 180 of cleated shoe(s) 104. Cleats 180 are shown in dotted lines to indicate how they are received within auxiliary sole 110. First set of straps 140, second set of straps 150 and third set of straps 160 are shown in a coupled condition such that forward and backward relative movement is limited.

Referring now to FIG. 4, illustrating a top perspective view of midsole 130 of cleat sole protection system 100 according to an embodiment of the present invention of FIG. 1.

As shown, cleat receiving apertures 170 are located in midsole 130 and in an upper portion of outer sole 120. Auxiliary sole 110 comprises cleat receiving apertures 170 preferably comprising a pattern matching the arrangement of cleats 180 on cleated shoe(s) 104. Cleat receiving apertures 170 may comprise cubic profile apertures 230 and/or cylindrical profile apertures 240. Apertures 230 comprise inner volumes to receive cleats 180. Only cleats 180 portions of the bottom of cleated shoe(s) 104 are contained partially within auxiliary sole 110. First set of straps 140 and second set of straps 150 are shown in an uncoupled condition, other embodiments as shown in previous FIGS. 1-3 may have third set of straps 160 for controlling movement of cleat sole 102 in relation to cleated shoe(s) 104.

Upon reading this specification, it should be appreciated that, under appropriate circumstances, considering such issues as user preferences, design preference, structural requirements, marketing preferences, cost, available materials, technological advances, etc., other fastening arrangements such as buckling strap systems, other fractioning arrangements, ties, elastics, etc., may be sufficient.

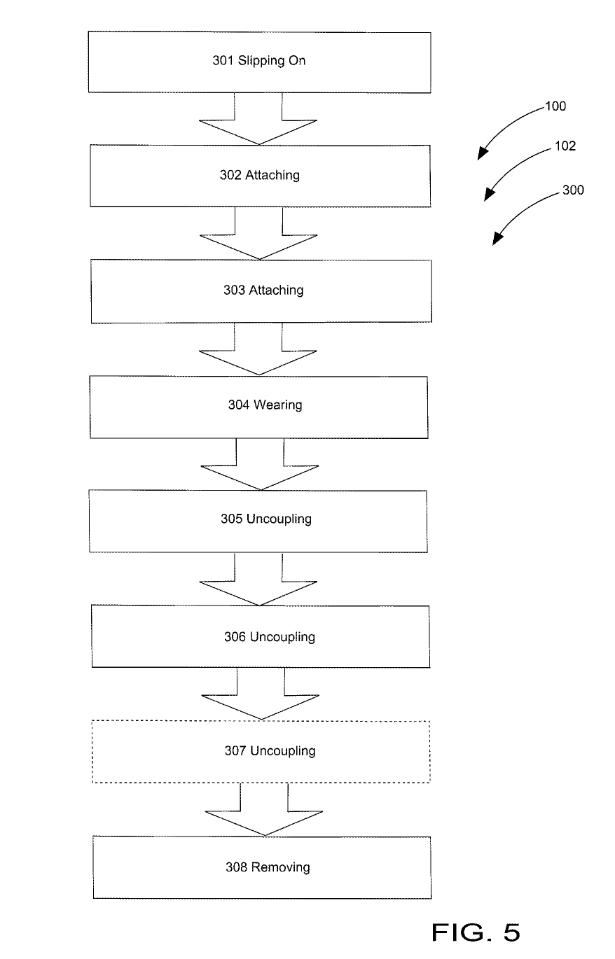

Referring now to FIG. 5, a flowchart illustrating a method of use 300 of cleat sole protection system 100 according to an embodiment of the present invention of FIG. 1. A method of use 300 for cleat sole protection system 100 may comprise the steps of: step one 301, slipping on an auxiliary sole 110; step two 302, attaching a first set of straps 140 about cleated shoe(s)₁₀₄; step three 303, attaching a second set of straps 150 about cleated shoe(s)₁₀₄; step four 304, wearing auxiliary sole 110 of cleat sole protection system 100 to prevent touch-contact between cleated shoe(s)₁₀₄ and a planar surface; step five 305, uncoupling second set of straps 150; step six 306, uncoupling first set of straps 140; and step eight 308, removing cleat sole protection system 100 from cleated shoe(s)₁₀₄ such that a wearer-user is able to engage in at least one activity.

The method of use for a cleat sole protection system 100 may further comprise the step of: step seven 307, uncoupling third set of straps 160 from around cleated shoe(s)₁₀₄ before removing cleat sole protection system 100.

It should be noted that step 307 is an optional step and may not be implemented in all cases. Optional steps of method 300 are illustrated using dotted lines in FIG. 5 so as to distinguish them from the other steps of method 300.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cleat sole protection system comprising:
an auxiliary sole having an outer sole and a midsole;
at least one first set of straps; and
at least one second set of straps;
wherein said auxiliary sole comprises cleat receiving apertures;
wherein said cleat receiving apertures are located in the midsole and an upper portion of said outer sole;
wherein said first set of straps and said second set of straps are non-removably attached to said auxiliary sole; and
wherein said first set of straps and said second set of straps are removably attachable around a cleated shoe such that contact is prevented between cleats of said cleated shoe and a planar surface while said auxiliary sole is removably attached to said cleated shoe.

2. The cleat sole protection system of claim 1 wherein said outer sole comprising a grip surface.

3. The cleat sole protection system of claim 1 wherein said outer sole comprising a non-grip surface.

4. The cleat sole protection system of claim 1 wherein said auxiliary sole comprises a wedge profile such that a heel portion of said cleat sole system is thicker than a toe portion.

5. The cleat sole protection system of claim 1 wherein said cleat receiving apertures comprise a pattern matching an arrangement of said cleats on said cleated shoes.

6. The cleat sole protection system of claim 1 wherein said cleat receiving apertures comprise cubic profile apertures.

7. The cleat sole protection system of claim 1 wherein said cleat receiving apertures comprise cylindrical apertures.

8. The cleat sole protection system of claim 1 wherein said auxiliary sole is flexible.

9. The cleat sole protection system of claim 5 wherein said outer sole comprises a protector such that said cleats of said cleated shoes are protected from wear and said planar surface is protected from impact-damage from said cleats.

10. The cleat sole protection system of claim 1 wherein said auxiliary sole does not comprise side-engaging portions.

11. The cleat sole protection system of claim 1 wherein said cleat sole does not comprise covered toe inclusive portions or heel inclusive portions so as to define front and backwards movement limits.

12. The cleat sole protection system of claim 1 wherein said auxiliary sole comprises a sandal profile.

13. The cleat sole protection system of claim 12 wherein said auxiliary sole does not comprise cleated shoe recesses wherein a sole-portion and a heel of the cleated shoe are recessibly-contained partially therein.

14. The cleat sole protection system of claim 1 further comprising a third set of straps.

15. The cleat sole protection system of claim 14 wherein said third set of straps couples to said second set of straps to prevent movement of said cleated shoe in relation to said auxiliary sole.

16. The cleat sole protection system of claim 13 wherein said sandal profile provides that said cleated shoe rides on an upper surface of said auxiliary sole such that said cleated shoe is not recessed within said auxiliary sole, that only said cleats are received within inner confines of said auxiliary sole.

17. A cleat sole protection system comprising:
an auxiliary sole having an outer sole and a midsole;
at least one first set of straps;
at least one second set of straps; and
at least one third set of straps;
wherein said auxiliary sole is flexible or non-flexible;
wherein said auxiliary sole comprises a wedge profile such that a heel portion of said cleat sole protection system is thicker than a toe portion;
wherein said auxiliary sole comprises a sandal profile;
wherein said outer sole comprising a grip or a non-grip surface texture;
wherein said auxiliary sole comprises cleat receiving apertures comprising a pattern matching the arrangement of cleats on said cleated shoe(s);
wherein said cleat receiving apertures comprise cubic profile apertures and/or cylindrical apertures;
wherein said cleat receiving apertures are located in the midsole and in an upper portion of said outer sole;
wherein said auxiliary sole does not comprise cleated shoe recesses wherein portions of bottom of said cleated shoe are contained partially therein;
wherein said sandal profile provides that said cleated shoe rides on an upper surface of said auxiliary sole such that said cleated shoe is not recessed within said auxiliary sole;
wherein said first set of straps and said second set of straps are non-removably attached to said auxiliary sole;
wherein said first set of straps and said second set of straps are removably attached around said cleated shoe such that contact is insulatably-prevented between said cleated shoe and a planar surface;
wherein said third set of straps couples to said second set of straps to prevent movement of said cleated shoe in relation to said auxiliary sole;
wherein said auxiliary sole does not comprise side engaging portions;
wherein said cleat sole does not comprise toe inclusive portions or heel inclusive portions so as to define front and backwards movement; and
wherein said outer sole comprises a protector such that said cleats of said cleated shoes are protected from wear and said planar surface is protected from damage from said cleats while said auxiliary sole is removably attached to said cleated shoe during a non-cleat-use period.

18. A method of use for a cleat sole protection system comprising the steps of:
slipping on an auxiliary sole;
attaching a first set of straps to a cleated shoe;
attaching a second set of straps to said cleated shoe;
wearing said auxiliary sole of said cleat sole protection system to prevent touch-contact between said cleated shoe and a planar surface;
uncoupling said second set of straps;
uncoupling said first set of straps; and
removing said cleat sole protection system from cleated shoe(s) such that a wearer-user is able to engage in at least one activity.

19. The method of use for a cleat sole protection system of claim 18 further comprising the step of attaching a third set of straps about said cleated shoe when preparing to wear said cleat sole protection system to prevent forward and backward movement of said cleated shoe in relation to said auxiliary sole.

20. The method of use for a cleat sole protection system of claim 19 further comprising the step of uncoupling said third set of straps from around said cleated shoe before removing said cleat sole protection system.
